(19) United States
(12) Patent Application Publication
(10) Pub. No.: US 2011/0049951 A1
(43) Pub. Date: Mar. 3, 2011

(54) PORTABLE CHAIR COVER FOR STACKABLE CHAIRS

(76) Inventor: Sienna M. Bettencourt, Goodyear, AZ (US)

(21) Appl. No.: 12/548,684

(22) Filed: Aug. 27, 2009

(51) Int. Cl. A47C 27/00; A47C 31/00; B68G 7/05

(52) U.S. Cl. 297/229; 29/91.1

(57) ABSTRACT

A chair cover for use with a seat includes first and second layers. A pocket formed between the layers holds removable pad. Chair cover rim includes an elastic band to secure cover to a chair. A tether is attached to one of the layers to allow the cover to be easily stored in a compact form.

### FIELD OF THE INVENTION

The present invention relates generally to chair coverings. More particularly, the invention relates to a portable chair cover cloth for standard children's chairs.

### BACKGROUND OF THE INVENTION

In today's classrooms for children, seating is provided to assist with the pedagogy of children. Seats used in these classrooms are often of a miniature size to allow smaller children to make use of chairs. These chairs are often of small size and standard shape. Often these chairs are stackable, however, sometimes chairs are equipped or attached to a hard planar desktop so as to form a one-piece desk.

Chairs in common use include a metal frame or base attached to a plastic seat. The base includes four legs attached to a mount. Sometimes, these legs come in a pair of upside down quasi-U-shaped legs that are mounted on a base. A hard plastic seat is permanently attached to the base. The seat will often have a somewhat flat (or other ergonomically shaped) horizontal bottom, and a back. Oftentimes these chair include a single molded plastic seat that includes both seat and back, however it is known in the art to provide such seats with ergonomic apertures and/or provide a separated seat and back portion that are bound through a base back.

Generally, the chairs are a convenient method of seating children, as the chairs are generally light weight and resilient. However, drawbacks for these chairs include the lack of comfort (especially prominent in active children who do not feel comfortable sitting for long periods of time any way). The hard plastic chairs can also provide pain in children when long periods of sitting can cause vasoconstriction in portions of the body that are pressed against the seat surface.

Further, as the chairs are generally interchangeable, many children often use the same chair through out the day. This, along with the unsanitary nature of many immature children, can cause the chairs to act as microbial growth stations that can lead to spread of bacteria and disease.

A chair cover is intended for student chairs to help solve several problems. Common and reoccurring comments from students include incorrect posture leading to muscle fatigue and bone misalignment, uncomfortable contact with a chair surface, and general discomfort with standard sized chairs. Furthermore, some children sense an unfair disadvantage to students or others who seem more comfortable in cushioned chairs. The comment list goes on and on. Unfortunately, the comments students make are true. They are often uncomfortable all day!

First and foremost, the chair cover may alleviate student discomfort to allow better focus on classroom instruction. A chair cover provides a sanitary solution. Cushion is easily removed so cover can be washed and used multiple times.

A cozy seat cover can be rolled up and secured to easily fit into any backpack or carried using the shoulder strap. This makes it easy for students to transport a chair cover from class to class, or from home to school.

Students are able to choose from a variety of printed fabrics that match their personality and personalize their own space.

Therefore, there exists a need to provide a comfortable solution or complement to the standard hard body chairs. Furthermore, there exists a need for a hygienic solution to classroom and other seating arrangements. Others have attempted to provide solutions with elaborate or disposable chair covers.

### OBJECTS OF THE INVENTION

It is therefore an object of the present invention to provide a chair cover that will ease the comfort of a seated person.

It is another object of the present invention to provide a chair cover that is easily transported and applied to a chair.

It is yet another object of the present invention to provide a hygienic chair cover solution to protect a user from potential pathogens on seating apparatuses.

It is still another object of the present invention to provide a method for covering a chair so as to provide support, comfort, hygiene and/or fashion to the user.

It is still yet another object of the present invention to provide a portable chair cover that can be easily applied to a first chair, transported, and applied to the same and/or other chair.

It is an additional object of the present invention to provide a comfortable seated experience.

These and other objects of the present invention will become more apparent to those skilled in the art as the description of the present invention proceeds.

### SUMMARY OF THE INVENTION

According to one aspect of the present invention, a method of covering a chair, the chair having a hard solid back and a hard solid seat, the hard solid back having an upper portion and a lower portion, the hard solid seat having a posterior portion and an anterior portion with the lower portion of the hard solid back being proximate to the posterior portion of the hard solid seat, the hard solid back having a length in the direction from the upper portion to the lower portion and a width, the hard solid seat having a length in the direction from the upper posterior portion to the anterior portion and a width which is approximately the same as the width of the hard solid back. One can produce a cloth cover with an inner layer and an outer layer and a space between the inner layer and outer layer, the cloth covering having a reclosable opening, the cloth cover has a length that is approximately the same length as the combined length of the hard solid back and the hard solid seat, and the cloth cover has a width that is approximately the same as the width of the hard solid seat and back. The cloth cover has one or more extension pieces of cloth connected to the cloth cover to extend around and cover part of the hard solid back of the chair at the upper portion of the back and to extend around and cover part of the hard solid seat of the chair at the anterior portion of the seat. A foam pad, approximately the same length as the length of the cloth cover, and approximately the same width as the width of the cloth cover, fits inside the cloth cover. A foam pad is inserted into the cloth cover through the reclosable opening. The cloth cover is placed onto a chair by extending the one or more extension pieces of cloth around the upper portion of the hard solid back of the chair and around the anterior portion of the hard solid seat of the chair. A tether may be attached to the cloth cover at one or more distinct points along the cloth cover. The tether may be attached at along line intersecting the mid point of the cloth cover. The cover may be rolled up for storage, whereby the tether is set around the cover forming a portable case. The cover may then be unrolled for re-use. To maintain and/or wash the cover, the pad may be removed from the layers. The cover may be applied to a chair with an elastic band and may be secured to the chair with a friction material on one layer.

The present invention also includes an apparatus chair cover for use with a standard chair. A first layer is set for engaging a seated user, which may be a single fabricated sewn layer including darts cut out of corners, and a second layer is disposed opposite and generally co-planer with said first layer. The first and second layers are bound together along a first circumferential edge. A padding layer is disposed between said first and said second layers. An elasticized binder is disposed along the second circumferential edge. An opening along the second layer allows for removal of the padding layer. A retaining strap is formed in a loop, whereby the loop is coupled to the second layer at at least one point. The second circumferential edge may extend over a portion of the second layer, thus exposing the first layer around a working edge. A mounting strap may be used to secure an applied chair cover to the chair. The aforementioned opening may be a pocket wherein the first layer extends around the first circumferential edge to fold over the padded layer. The retaining strap may be is elasticized. The elasticized binder may be an elastic substance sewn directly onto the first layer. If necessary, at least one of the layers can be made out of an anti-microbial fabric.

### BRIEF DESCRIPTION OF THE DRAWINGS

The present invention may more readily be understood by reference to the accompanying drawings in which:

FIG. 1 is a perspective view of a chair with the chair cover provided thereupon;

FIG. 2 is a reverse perspective view of the chair with cover shown in FIG. 1;

FIG. 3 is a view of an embodiment of the present invention chair cover back;

FIG. 4 is a perspective view of an embodiment of the present invention rolled into a compact storage position;

FIG. 5 is a view of an embodiment of the present invention chair cover front;

FIG. 6 is a side view of the an embodiment of the present invention;

FIG. 7 is a cross-sectional view of the embodiment of the invention taken along line 7-7 of FIG. 5.

FIG. 8 is a view of an alternative embodiment of the present invention chair cover front;

FIG. 9 is a view of an alternative embodiment of the present invention chair cover back.

### DETAILED DESCRIPTION OF THE PREFERRED EMBODIMENTS

Referring to FIGS. 1 and 2, cover 1 is positioned upon chair 6. Chair 6 is preferably a standard plastic molded single piece chair with metal base 8 supported by legs 7. Base 8 is generally bolted or riveted onto chair 6 with bolts 9. Chair 6 may include ergonomic and/or ventilation slits 10 for maximum comfort, portability, lower manufacturing costs, and other benefits known in the art. Although a preferred embodiment is sized and positioned for a small child's molded chair, it is envisioned that chair cover 1 can be modified and prepared for most chairs that include at least a seat such that the rim of the seat provides anchoring for chair cover 1. Preferably chair cover is made of multiple panels of fabric, preferably cotton or canvas. It is also preferred that paneling includes a design or coloring to help personalize and distinguish various chair covers.

Front panel 2 of chair cover 1 is exposed as an alternative seating surface for the chair user. Ridge 3 of chair cover 1 provides enough material to extend over edges or contours of chair 6 so as to secure cover 1 to chair 6. Chair cover 1 may include a mid-section 12, wherein an alternative embodiment, for particular chair size or when there is a significant angle between the chair back and seat, mid-section 12 may include a softer bendable line, or a break of cushion material coinciding with an inserted cushion, or any other reasonable attribute that assists chair cover placement or comfort.

Chair cover 1 has back ring 4 which may be placed over edges or contours of chair 6 and thereby help secure chair cover 1 to chair 6. It is contemplated that ring 4 includes an elasticized band 5. Band 5 may be separate rubber band encapsulated within the material of chair cover 1, or as in the preferred embodiment, an elasticized ring sewn directly into the material of the cover 1, preferably into front panel 2. By sewing band 5 directly into the material, there is less likelihood that band 5 will shift or be damaged. Ring 4 is preferably part of the same sheet as front panel 2, folded over to create ring 4 and space for band 5.

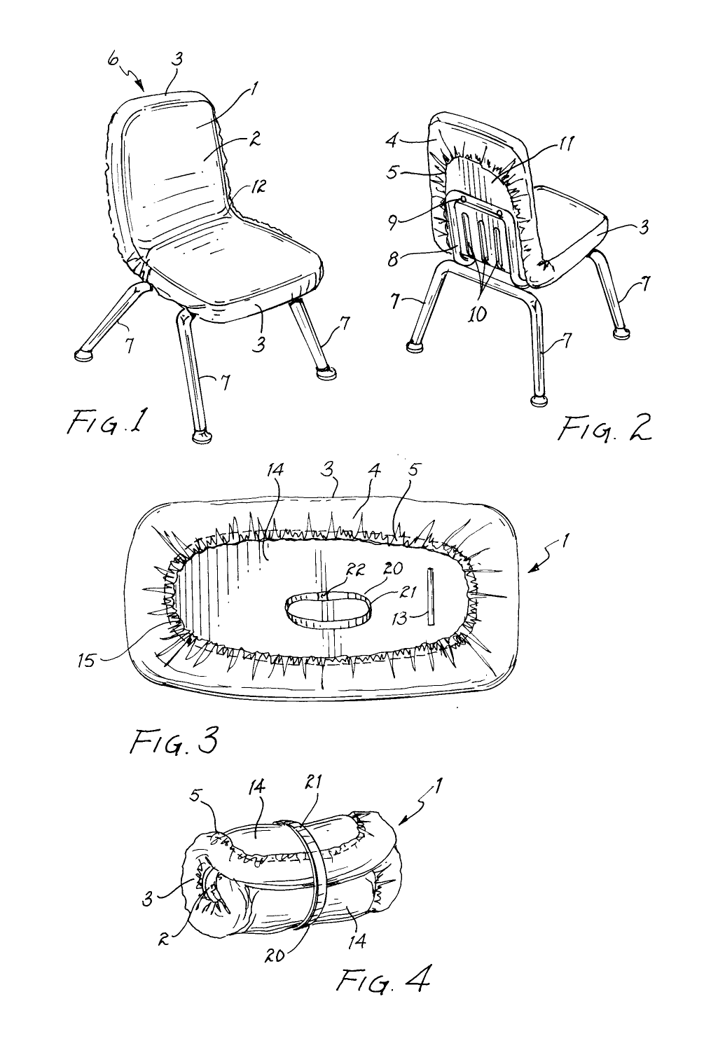

Referring to FIG. 3, back features of the chair cover 1 are not normally apparent to a user preparing to sit, or one seated on the chair. Ridge 3 forms the circumference of chair cover 1, and has a general form so as to fit properly over a select chair. Back ring 4 includes band 5 as described above. Ring 4 is set within crumple zone 15. Crumple zone 15 is preferably an area where excess material of chair cover 1 is allowed to overlap and/or pleat in a preferably random manner, whereby overlaps are kept to a minimum. Crumple zone 15 allows for expansion of back ring 4 and band 5 to allow chair cover 1 ridge 3 to be properly applied over chair contours. Crumple zone 15 also simplifies manufacture of cover 1 panels (front 2 shown in FIG. 1, and back 14) so as to allow a single fabric sheet to serve as template for a panel. Back panel 14 is preferably a rectangular piece sewn onto the underside of front panel 2. Back panel 14 may include gripper 13. Gripper 13 is a bar, or portion of material, that has a friction coefficient greater than that of the material forming back panel 14. Gripper 13 further secures chair cover 1 to the chair surface. Back panel 14 also includes loop 20. Loop 20, or tether, functions to allow for ease of storage and portability of chair cover 1 when not in use. When applied to a chair, loop 20 should be thin enough so as not to discomfort a seated user. Loop includes loop ring 21, preferably made of threaded elastic material. Loop ring 21 forms an elastic belt that can rotate, flip and stretch to allow for entire circumference of a folded chair cover 1 to be fit within loop ring 21. Loop 20 is mated with back panel 14 of chair cover 1 at connection point 22. Connection point 22 can be a single stitch, or shaped stitched area (reference numeral 24 in FIG. 7), preferably a square of dimensions just less that width of loop ring 21 at rest. Preferably, when loop ring 21 is stretched, loop ring width decreases to a width less than that of dimension of connection area 22.

Referring to FIG. 4, chair cover 1 is seen in compacted form. Front panel 2 is mainly obscured and protected when chair cover 1 is rolled up as shown. Back panel 14 provides much of the outer surface that is exposed when in this compacted form. Thus, front panel 2 may be protected and kept clean for the user during transport or storage. Ridge 3 also serves to form edges that further protect user engaging portions of front panel 2. Band 5 is set along the exterior perimeter to form a somewhat soft shell. Loop may be set around chair cover 1 with loop ring 21 properly holding chair cover 1 in this position.

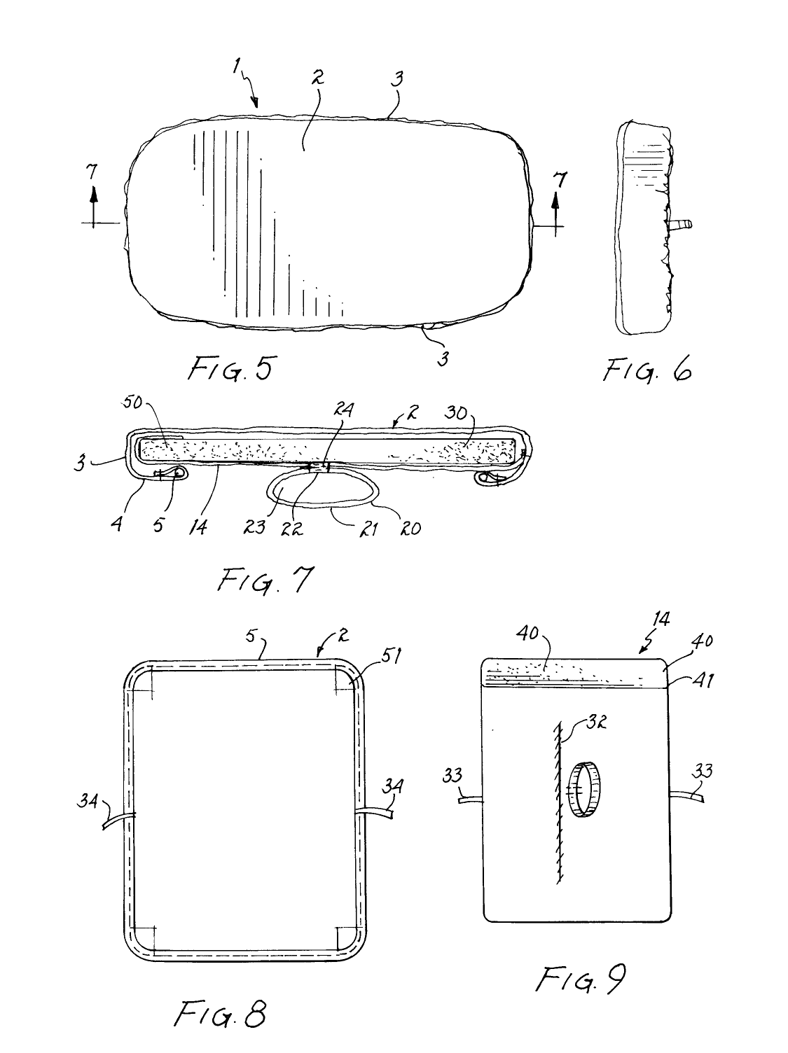

Referring to FIGS. 5-9, Front panel 4 underside mates with back panel 14, in the absence of any padding layer. It is preferred that back panel 14 is stitched to front panel 2 on three of four sides, leaving one of the short ends open. This opening between front and back panel forms pouch 50. Pad 30 may be inserted into pouch 50. Back panel 14 may include pocket 40, which is created by doubling under the material of back panel 14 at the opening for pouch 50. Thus a catch, or pocket 40, holds pad 30 in pouch 50, preventing pad from slipping out of pouch 50. Pad 30 is preferably formed to fill the dimensions of back panel 14. Padding is preferably malleable enough to fit into pouch 50 and then be maneuvered under pocket 40 to be held in double-back 41 of pocket 40.

Front panel 2 having rounded edges, is folded under itself to house sown in elastic band 5. Elastic band 5 may be separate band enclosed in wrap over portion of front panel 2, or the elastic band may be sewn into the fabric of front panel 2. Back panel 14 may form a pouch of preferably rectangular shape, set at under side of front panel 2. Back panel 14 is preferably attached at three sides, leaving, preferably one of the short ends, e.g. top or bottom open. It is preferred that the back panel 14 is folded under at double-back 41 so that the edge of back panel 2, those near the opening of pouch 50, include doubled-over portion 41. This doubled over portion 41 acts as a catch to prevent pad 30 from removing from pouch 50.

Note, FIG. 7 shows an alternative embodiment whereby band 5 is a separate entity from front panel 2 and is not sewn directly into the fabric.

FIG. 8 demonstrates front panel 2. Band 5 may be sewn along perimeter of fabric. Cut outs 51, at each corner, may be used to allow for the front panel 2 to assume a proper shape to stretch around and hug a chair contour. FIG. 9 demonstrates back panel 14, which is preferably smaller than front panel 2. Optionally, back panel may be sewn onto front panel 2 along all four edges. In this case, zipper 32 allow access to pouch 50. Chair cover may include security straps 33, or a loop, to secure chair cover 1 to a chair. Further, chair cover 1 may include a seat belt 34, or loop or fasteners, to secure a seated user to chair cover 1.

The present invention has been described in terms of selected specific embodiments of the invention incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed is:

1) A method of covering a chair, the chair having a hard solid back and a hard solid seat, the hard solid back having an upper portion and a lower portion, the hard solid seat having a posterior portion and an anterior portion with the lower portion of the hard solid back being proximate to the posterior portion of the hard solid seat, the hard solid back having a length in the direction from the upper portion to the lower portion and a width, the hard solid seat having a length in the direction from the upper posterior portion to the anterior portion and a width which is approximately the same as the width of the hard solid back, the method comprising the steps of:
a) producing a cloth cover with an inner layer and an outer layer and a space between the inner layer and outer layer, the cloth covering having a reclosable opening,
b) the cloth cover having a length that is approximately the same length as the combined length of the hard solid back and the hard solid seat, and the cloth cover having a width that is approximately the same as the width of the hard solid seat and back,
c) the cloth cover having one or more extension pieces of cloth connected to the cloth cover to extend around and cover part of the hard solid back of the chair at the upper portion of the back and to extend around and cover part of the hard solid seat of the chair at the anterior portion of the seat;
d) producing a foam pad approximately the same length as the length of the cloth cover, and approximately the same width as the width of the cloth cover, to fit inside the cloth cover;
e) inserting the foam pad into the cloth cover through the reclosable opening;
f) closing the reclosable opening;
g) placing the cloth cover on the chair by extending the one or more extension pieces of cloth around the upper portion of the hard solid back of the chair and around the anterior portion of the hard solid seat of the chair.

2. The method of claim 1 further comprising the step of attaching a tether to the cloth cover at two distinct points along the cloth cover.

3. The method of claim 2 wherein the step of attaching the points comprise a line intersecting the mid point of the cloth cover.

4. The method of claim 2 further comprising the steps of:
rolling up the cloth cover; and
stretching strap around so as to form portable case.

5. The method of claim 4 further comprising the step of unrolling the cloth cover for re-use.

6. The method of claim 1 further comprising the steps of:
removing the pad from the cloth cover, and
washing the cloth cover.

7. The method of claim 1 wherein the cloth cover includes elastic means for holding onto chair, elastic wrap.

8. The method of claim 1 wherein the cloth cover comprises means for securing the cloth cover to the chair.

9. The method of claim 8 wherein means for securing comprises a friction strip along the second layer.

10. A chair cover for use with a standard chair, comprising:
a) a first layer for engaging a seated user;
b) a second layer disposed opposite and generally co-planer with said first layer;
c) wherein said first and second layers are bound together along a first circumferential edge;
d) a padding layer disposed between said first and said second layers;
e) an elasticized binder disposed along a second circumferential edge; and
f) a retaining strap formed in a loop, whereby the loop is coupled to said second layer at at least one point.

11. The chair cover of claim 10 wherein the second circumferential edge extends over a portion of said second layer, thus exposing said first layer around a working edge.

12. The chair cover of claim 10 further comprising at least one mounting strap to secure an applied chair cover to the chair.

13. The chair cover of claim 10 further comprising an opening along said second layer to allow for removal of said padding layer.

14. The chair cover of claim 13 wherein said opening comprises a pocket wherein said first layer extends around the first circumferential edge to fold over said padded layer.

15. The chair cover of claim 10 wherein said retaining strap is elasticized.

16. The chair cover of claim 10 wherein said elasticized binder comprises a elastic substance sewn directly onto said first layer.

17. The chair cover of claim 10 wherein at least one of said first and second layers comprises an anti-microbial fabric.

18. The chair cover of claim 10 wherein said first layer is a single fabricated sewn layer including darts cut out of corners of the first layer.
